(19) United States
(12) Patent Application Publication
(10) Pub. No.: US 2019/0035222 A1
(43) Pub. Date: Jan. 31, 2019

(54) System which allows real currency exchanges for Online strategic games

(71) Applicant: Noah Kreiger, Winston-Salem, NC (US)

(72) Inventor: Noah Kreiger, Winston-Salem, NC (US)

(21) Appl. No.: 15/658,781

(22) Filed: Jul. 25, 2017

(51) Int. Cl. G07F 17/32

(52) U.S. Cl. CPC G07F 17/3288; G07F 17/3225; G07F 17/3295; G07F 17/3244; G07F 17/3293; G07F 17/3211

(57) ABSTRACT

This current invention a system and application in which the user can bet on strategy games such as chess and checkers. The process would be that a user would register and login. They would select the game that they would want to play. Next, the user would place a bet or a stake on the game. The system would keep track of the user's bets, stakes, results and balance.

### CROSS-REFERENCES TO RELATED APPLICATIONS (IF ANY)

None

### BACKGROUND

### 1. Field of the Invention

The present invention relates to a process for online gaming and more particularly allowing currency exchanges based on stakes and wagers.

### 2. Description of Prior Art

People enjoy playing strategy games and more and more people are doing it online. People are very competitive and sometimes like to bet on the outcome of a particle game. There is currently no easy way to do this especially when people are in different locates or different parts of the world.

There is still room for improvement in the art.

### SUMMARY OF THE INVENTION

The current invention is system and application in which the user can bet on strategy games such as chess and checkers.

The system, in the preferred embodiment, would work like a smartphone application, this product would be available through the respective marketplace for smartphones.

The process would be that a user would register and login. They would select the game that they would want to play. Next, the user would place a bet or a stake on the game. The system would keep track of the user's bets, stakes, results and balance.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a sample of a login screen;

FIG. 3 shows a sample of a select a game screen;

FIG. 4 displays the set a bet or stake screen;

FIG. 5 displays an account screen on the wager and balance;

FIG. 6 shows the leaderboard; and

FIG. 7 shows a sample game such as checkers.

### DESCRIPTION OF THE PREFERRED EMBODIMENT

There are a number of significant design features and improvements incorporated within the invention.

The current invention is a system and application that would allow users to bet on strategy games such as chess and checkers.

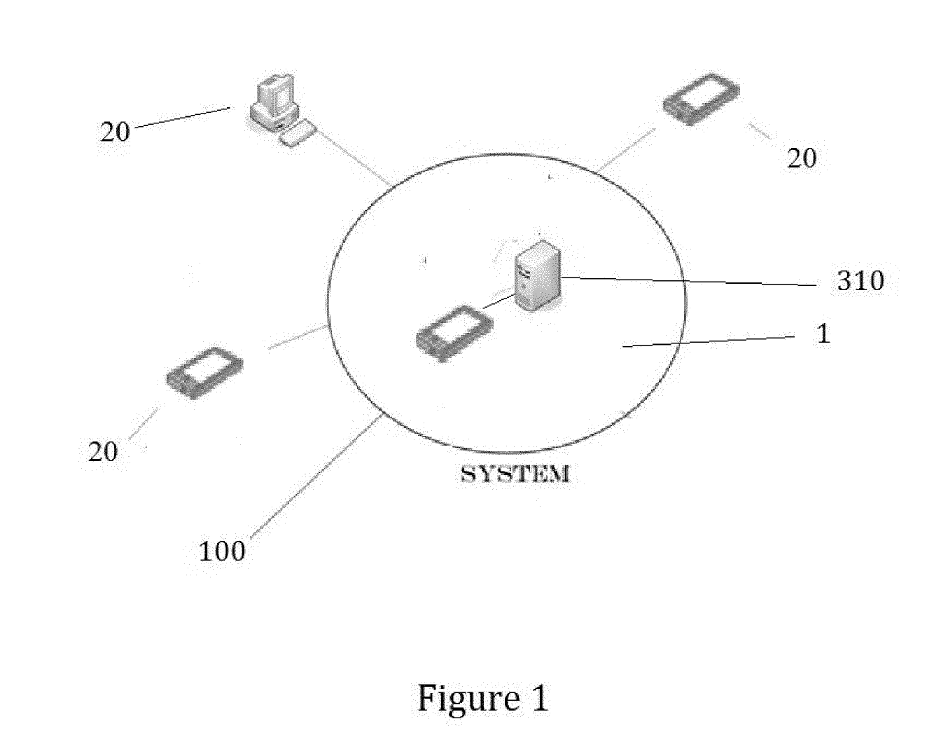

FIG. 1 displays the preferred embodiment of the system architecture 1 accessed through an Internet, Intranet and/or Wireless network 500. However, the system could be implemented on a device-to-device or client/server architecture as well.

In FIG. 1, the system 1 is accessed from a user's computing device 10 through a web browser over HTTP and/or HTTPS protocols 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each computing device 10 or smartphone communicating with others within the system 1.

The system 1, data and processing code can reside in the non-transitory memory 310 of the one or more computing devices. The system 1 in the preferred embodiment would be written to act like a smart phone application (app).

### Brief Overview

This current invention is a system 1 and app is aimed to make it easy for people to play strategy games and place bets on those games. It is a system and computer application (app) in which the user can select a strategy game to play such as checkers or chest and then bet on the outcome of the game. The system 1 will include each user features that can process separately from the other or combined.

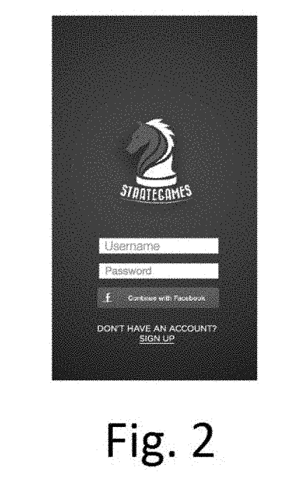

The users would sign-in directly or using social logins as shown in FIG. 2 with the user registering the app,

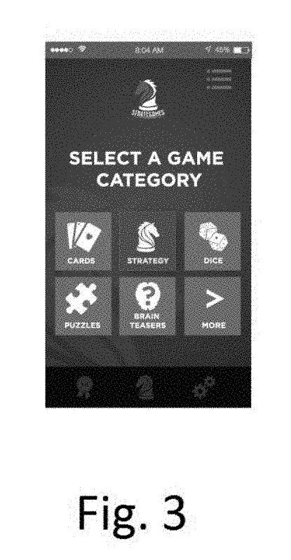

The user will set up their profile for the system using a profile screen. The user will select a game to play from a list of game types such as brain teasers, strategy games, card games, dice games or puzzles as shown in FIG. 3.

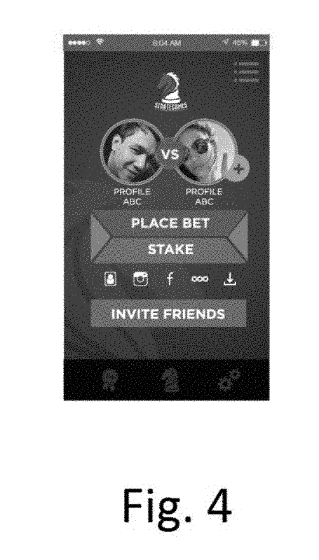

The system 1 will allow a user to set a bet on the games select as well as having a options to invite a friend as shown in FIG. 4. A payment screen will be set up account details to accept any normal method of payment.

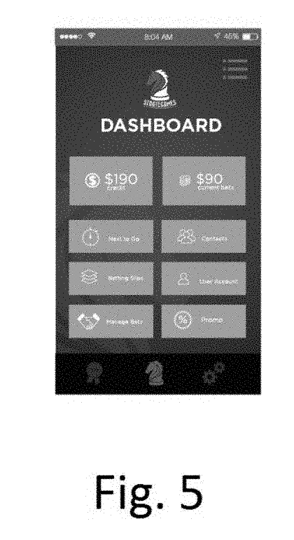

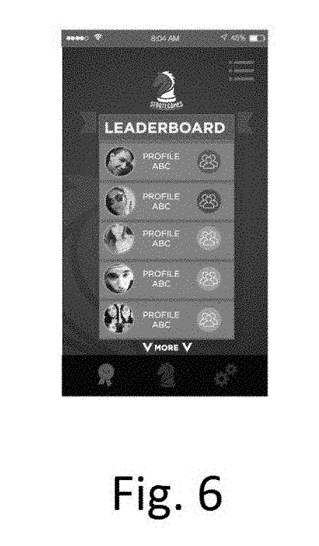

The system 1 will on a management screen that will allow a user to manage their bets and their account as shown in FIG. 5. It will allow a user to manage their bets and contacts. FIG. 6 shows a screens shot of a leaderboard showing the ranking of the players.

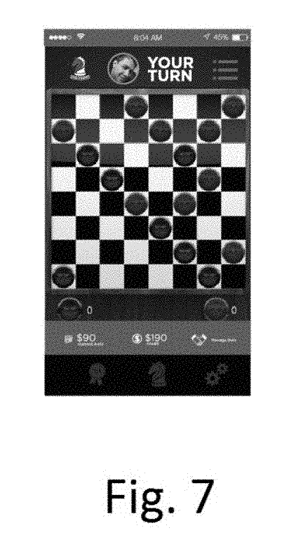

The system 1 will allow you to play the requested game such as checkers as shown in FIG. 7. The user will either pay or receive a payment based on the amount bet and the odds on the game.

The system 1 can provide each feature either separately or combined together.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
displaying a plurality of games to be play; selecting a game to be play, selecting a bet to be placed on the game, playing the game, and paying a payment if the player loses or receiving a payment if the player wins.

2. A system according to claim 1 keeping the user's balance.

3. A system according to claim 1 proving a ranking of the users.

4. A system according to claim 1 where the games can be one or more of a set of brain teasers, strategy games, card games, dice games or puzzles.
